(19) United States
(12) Patent Application Publication
(10) Pub. No.: US 2026/0002833 A1
(43) Pub. Date: Jan. 1, 2026

(54) LASER DEVICE AND DETERIORATION DETERMINATION METHOD OF OPTICAL ELEMENT

(71) Applicant: Gigaphoton Inc., Oyama-shi (JP)

(72) Inventor: Natsuhiko KOUNO, Oyama-shi (JP)

(73) Assignee: Gigaphoton Inc., Oyama-shi (JP)

(21) Appl. No.: 19/321,824

(22) Filed: Sep. 8, 2025

Related U.S. Application Data
(63) Continuation of application No. PCT/JP2023/015219, filed on Apr. 14, 2023.

(51) Int. Cl. G01M 11/02

(52) U.S. Cl. CPC G01M 11/0207

(57) ABSTRACT

A laser device includes an optical element arranged on an optical path of laser light; a movement mechanism configured to move the optical element in a direction along a surface of the optical element on which the laser light is incident; a beam measurement device configured to measure the laser light via the optical element; and a processor configured to acquire first output data output from the beam measurement device when the laser light is radiated to a first portion of the optical element, move the optical element after acquiring the first output data by driving the movement mechanism, acquire second output data output from the beam measurement device after the movement when the laser light is radiated to a second portion of the optical element different from first the portion, and determine deterioration of the optical element based on the first output data and the second output data.

### CROSS-REFERENCE TO RELATED APPLICATIONS

The present application is a continuation application of International Application No. PCT/JP2023/015219, filed on Apr. 14, 2023, the entire contents of which are hereby incorporated by reference.

### BACKGROUND

### 1. Technical Field

The present disclosure relates to a laser device and a deterioration determination method of an optical element.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 10,095,118

Patent Document 2: U.S. Pat. No. 10,845,711

Patent Document 3: U.S. Pat. No. 7,379,251

Patent Document 4: Japanese Patent Application Publication No. 2000-12923

Patent Document 5: Japanese Patent No. 4197435

### SUMMARY

A laser device according to an aspect of the present disclosure includes an optical element arranged on an optical path of laser light; a movement mechanism configured to move the optical element in a direction along a surface of the optical element on which the laser light is incident; a beam measurement device configured to measure the laser light via the optical element; and a processor configured to acquire first output data output from the beam measurement device when the laser light is radiated to a first portion of the optical element, move the optical element after acquiring the first output data by driving the movement mechanism, acquire second output data output from the beam measurement device after the movement when the laser light is radiated to a second portion of the optical element different from the first portion, and determine deterioration of the optical element based on the first output data and the second output data.

A deterioration determination method of an optical element used for a laser device according to another aspect of the present disclosure includes acquiring first output data output from a beam measurement device configured to measure the laser light via the optical element when laser light is radiated to a first portion of the optical element; moving, after acquiring the first output data, the optical element in a direction along a surface of the optical element on which the laser light is incident; acquiring, after moving the optical element, second output data output from the beam measurement device when the laser light is radiated to a second portion of the optical element different from the first portion; and determining deterioration of the optical element based on the first output data and the second output data.

### BRIEF DESCRIPTION OF THE DRAWINGS

Embodiments of the present disclosure will be described below merely as examples with reference to the accompanying drawings.

FIG. 1 schematically shows the configuration of a laser device according to a comparative example.

FIG. 2 schematically shows the configuration of the laser device according to a first embodiment.

FIG. 3 schematically shows the configuration of a slide mechanism for moving a beam splitter.

FIG. 4 is a view showing states before and after the beam splitter is slid by the slide mechanism.

FIG. 5 is a flowchart showing an example of a deterioration determination method of the beam splitter.

FIG. 6 is an explanatory diagram of a method for calculating a parameter from two-dimensional data of a light intensity.

FIG. 7 schematically shows the configuration of the laser device according to a second embodiment.

FIG. 8 is a plan view schematically showing the configuration of a beam expander to which the slide mechanism is added.

FIG. 9 is a sectional view taken along line 9-9 of FIG. 8.

FIG. 10 is a plan view schematically showing the configuration of an output coupling mirror to which the slide mechanism is added.

FIG. 11 is a side view including a partial section of FIG. 10 viewed from a V direction.

FIG. 12 is a view showing states before and after the beam expander is slid by the slide mechanism.

FIG. 13 is a view showing states before and after the output coupling mirror is slid by the slide mechanism.

FIG. 14 is a flowchart showing an example of the deterioration determination method of an optical element in the laser device according to the second embodiment.

FIG. 15 schematically shows the configuration of the laser device according to a third embodiment.

FIG. 16 is an explanatory diagram of a method for calculating a parameter from the two-dimensional data of the light intensity.

FIG. 17 schematically shows the configuration of the laser device according to a first modification of the third embodiment.

FIG. 18 is an example of a pulse waveform obtained by a biplanar photoelectric tube.

FIG. 19 is a flowchart showing an example of the deterioration determination method of the beam splitter based on a pulse time width.

FIG. 20 schematically shows the configuration of the laser device according to a second modification of the third embodiment.

FIG. 21 schematically shows the configuration of the laser device according to a fourth embodiment.

FIG. 22 schematically shows the configuration of the laser device according to a fifth embodiment.

FIG. 23 schematically shows a configuration example of an exposure apparatus.

### DESCRIPTION OF EMBODIMENTS

### <Contents>

1. Overview of laser device according to comparative example
   1.1 Configuration
   1.2 Operation
2. Problem
3. First embodiment
   3.1 Configuration
   3.2 Operation
      3.2.1 Slide operation of beam splitter
      3.2.2 Operation flow of deterioration determination
   3.3 Calculation example of parameter
      3.3.1 Beam width (BPH, BPV) in each of H direction and V direction
      3.3.2 Beam cross-sectional area
      3.3.3 Difference between center of gravity and center of beam width (center difference)
   3.4 Example of deterioration determination
      3.4.1 Example of deterioration determination based on beam width
      3.4.2 Example of deterioration determination based on beam cross-sectional area
      3.4.3 Example of deterioration determination based on difference between center of gravity and beam width center (center difference)
   3.5 Effect
   3.6 Others
4. Second embodiment
   4.1 Configuration
   4.2 Operation
      4.2.1 Slide operation of beam expander
      4.2.2 Slide operation of output coupling mirror
      4.2.3 Operation flow of deterioration determination
   4.3 Effect
5. Third embodiment
   5.1 Configuration
   5.2 Operation
   5.3 Example of deterioration determination
   5.4 Effect
   5.5 Others
   5.6 First modification
      5.6.1 Configuration
      5.6.2 Operation
      5.6.3 Effect
   5.7 Second modification
      5.7.1 Configuration
      5.7.2 Operation
      5.7.3 Effect
6. Fourth embodiment
   6.1 Configuration
   6.2 Operation
   6.3 Effect
7. Fifth embodiment
   7.1 Configuration
   7.2 Operation
   7.3 Effect
   7.4 Modification
8. Comparison of output data of beam measurement device
9. Modification of laser device
10. Electronic device manufacturing method
11. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overview of Laser Device According to Comparative Example

### 1.1 Configuration

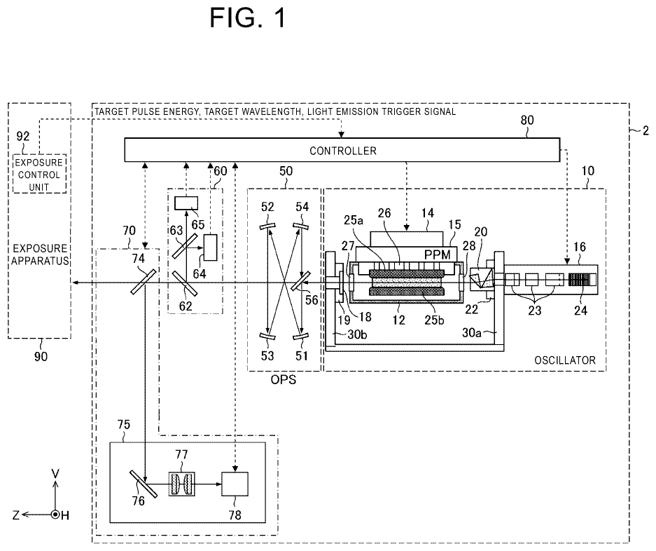

FIG. 1 schematically shows the configuration of a laser device 2 according to a comparative example. The comparative example of the present disclosure is an example recognized by the applicant as known only by the applicant, and is not a publicly known example admitted by the applicant. The laser device 2 is an excimer laser device including an oscillator 10, an optical pulse stretcher (OPS) 50, a monitor module 60, a beam measurement device 70, and a controller 80.

The OPS 50 and the monitor module 60 are arranged in this order on the optical path of the pulse laser light output from the oscillator 10. The oscillator 10 includes a chamber 12, a charger 14, a pulse power module (PPM) 15, an LNM 16, an output coupling mirror 18, a base 19, a beam expander 20, and a mount 22.

The LNM 16 includes a prism 23 and a grating 24, and an actuator (not shown) for changing an angle of the prism 23 or the grating 24 is connected to the controller 80. The output coupling mirror 18 and the LNM 38 configure an optical resonator, and the chamber 12 is arranged on the optical path of the optical resonator.

The chamber 12 is a laser chamber including a pair of discharge electrodes 25a, 25b, an insulating member 26, a front-side window 27, and a rear-side window 28. A laser gas capable of oscillating an ArF laser, a KrF laser, an XeCl laser, or an XeF laser is enclosed in the chamber 12.

The discharge electrode 25a and the discharge electrode 25b are arranged to face each other with a predetermined gap therebetween. The discharge electrode 25a is connected to a high voltage output line of the PPM 15 via the insulating member 26. The discharge electrode 25b is connected to the ground. A space between the discharge electrode 25a and the discharge electrode 25b is a discharge space.

The front-side window 27 and the rear-side window 28 are arranged so that pulse laser light generated in the discharge space is transmitted therethrough. The PPM 15 includes a switch (not shown) and is connected to a line for transmitting an ON signal for the switch from the controller 80.

The charger 14 is connected to the controller 80 and the PPM 15 to receive data of a charge voltage from the controller 80 and to supply a high voltage to charge a charging capacitor of the PPM 15.

The beam expander 20 is arranged between the rear-side window 28 and the LNM 16 and is fixed to a cavity plate 30a via the mount 22. The output coupling mirror 18 is fixed to a cavity plate 30b via the base 19.

The OPS 50 includes concave mirrors 51 to 54 and a beam splitter 56. A delay optical path length of the OPS 50 is set to L. The beam splitter 56 is arranged on the optical path of the pulse laser light, and is coated with a film that reflects a part of the pulse laser light and transmits the other part thereof. The reflectance of the beam splitter 56 is preferably about 60%.

The concave mirrors 51 to 54 are concave mirrors all having substantially the same focal length of f. The concave mirrors 51 to 54 are arranged so as to satisfy the following relationship. That is, arrangement is performed such that, with respect to the laser light reflected by the beam splitter 56, a first image at the beam splitter 56 is reversed and formed by the concave mirror 51 and the concave mirror 52, and then returns to the beam splitter 56 by the concave mirror 53 and the concave mirror 54 so that a second image is erected and formed. In this case, the delay optical path length L is 8f. Here, an amplifier including a laser chamber (not shown) may be arranged between the oscillator 10 and the OPS 50.

The monitor module 60 is arranged on the optical path of the pulse laser light output from the OPS 50, and includes a beam splitter 62, a beam splitter 63, a pulse energy measurement instrument 64, and a spectrum measurement instrument 65. The pulse energy measurement instrument 64 and the spectrum measurement instrument 65 are connected to lines for transmitting respective detection data to the controller 80.

The pulse laser light output from the laser device 2 is input to an exposure apparatus 90. The controller 80 is connected to an exposure control unit 92 of the exposure apparatus 90 via a communication line. The controller 80 receives target pulse energy data, a target wavelength, a light emission trigger signal, and other signals from the exposure control unit 92 via the communication line.

Each of the controller 80 and the exposure control unit 92 is configured using a processor. The processor is a processing device including a storage device in which a control program is stored and a CPU which executes the control program. The processor is specifically configured or programmed to perform various processes included in the present disclosure.

The beam measurement device 70 includes a beam splitter 74 and an intensity distribution measurement unit 75. The beam splitter 74 is arranged on the optical path of the pulse laser light transmitted through the beam splitter 62. A multilayer film having the same reflectance for P-polarized light and S-polarized light may be coated on a surface of the beam splitter 74. The other surface of the beam splitter 74 may be coated with an AR coating (anti-reflection film).

The intensity distribution measurement unit 75 includes a high reflection mirror 76, a transfer optical system 77, and an image sensor 78. The high reflection mirror 76 is arranged on the optical path of reflection light of the beam splitter 74. A multilayer film having the same reflectance for P-polarized light and S-polarized light may be coated on a surface of the high reflection mirror 76. The transfer optical system 77 includes a plurality of lenses and is arranged on the optical path of the reflection light of the high reflection mirror 76.

The image sensor 78 is a camera including two-dimensional charge coupled device (CCD) elements, and the CCD elements may be arranged at a position of an image where a laser beam is transferred by the transfer optical system 77.

The controller 80 is connected to a control signal line of an electronic shutter of the image sensor 78 so as to transmit a trigger signal of the electronic shutter of the image sensor 78 in synchronization with the light emission trigger signal from the exposure apparatus 90.

In the laser device 2, a shutter (not shown) may be arranged on the optical path of the pulse laser light between the beam splitter 74 and the exposure apparatus 90. Opening and closing of the shutter is controlled by the controller 80.

### 1.2 Operation

The controller 80 receives the target pulse energy, the target wavelength, and the light emission trigger signal from the exposure control unit 92. When the switch of the PPM 15 is turned ON in synchronization with the light emission trigger signal received by the controller 80 at a predetermined repetition frequency, a high voltage is applied between the discharge electrodes 25a, 25b of the oscillator 10. Accordingly, discharge occurs between the discharge electrodes 25a, 25b, and an excimer laser gas is excited.

As a result, laser oscillation occurs in the optical resonator configured by the LNM 16 and the output coupling mirror 18, and the line narrowed pulse laser light is output from the output coupling mirror 18. In FIG. 1, the travel direction of the pulse laser light output from the output coupling mirror 18 is represented by a Z direction. Among directions perpendicular to the Z direction, a direction parallel to the discharge direction between the discharge electrodes 25a, 25b is represented by a V direction, and a direction perpendicular to the V direction and the Z direction is represented by an H direction.

The pulse laser light output from the output coupling mirror 18 is extended to a predetermined pulse width as passing through the delay optical path of the OPS 50 a plurality of times.

A part of the pulse laser light having passed through the OPS 50 is reflected by the beam splitter 62, a part of the pulse laser light reflected by the beam splitter 62 is reflected by the beam splitter 63, and the pulse energy thereof is measured by the pulse energy measurement instrument 64. The wavelength of the pulse laser light transmitted through the beam splitter 63 is measured by the spectrum measurement instrument 65.

The controller 80 controls the charger 14 so that the difference between the target energy and the measured pulse energy approaches zero based on information obtained from the monitor module 60. Further, the controller 80 controls the LNM 16 so that the difference between the target wavelength and the measured wavelength approaches zero. When the controller 80 turns ON the switch of the PPM 15 in synchronization with the light emission trigger signal from the exposure control unit 92, the pulse laser light is output from the oscillator 10, the pulse width of the pulse laser light is extended by the OPS 50, and the pulse laser light having a pulse energy close to the target pulse energy and a wavelength close to the target wavelength is output from the laser device 2.

The pulse laser light output from the laser device 2 enters the exposure apparatus 90, and a resist such as a semiconductor wafer (not shown) is irradiated with the pulse laser light in the exposure apparatus 90.

Thus, when a light emission trigger signal is output from the exposure apparatus 90, the pulse laser light is output from the laser device 2 based on the light emission trigger signal. Further, the controller 80 outputs a close signal to the sensor in shutter of the image sensor 78 in synchronization with the light emission trigger signal, and acquires image data from the image sensor 78. The controller 80 obtains the light intensity distribution (beam intensity distribution) of the pulse laser light from the image data, which is output data of the image sensor 78.

### 2. Problem

The laser device 2 according to the comparative example can obtain the light intensity distribution of the pulse laser light using the beam measurement device 70. The controller 80 can detect deterioration in the beam quality by monitoring the light intensity distribution of the pulse laser light.

However, the laser device 2 according to the comparative example has the following problems. That is, although deterioration in the beam quality of the pulse laser light output from the laser device 2 can be detected, it is difficult to determine deterioration of the individual optical elements arranged on the laser light path in the laser device 2. Accordingly, the optical element in the laser device 2 is set to have a lifetime managed by a number of shots and operation time, and is replaced early before a lifetime is reached. Thus, in a method of uniformly replacing the optical element before the end of its lifetime based on the number of shots and the operation time, there is a case in which the optical element is replaced even in a usable state. It is an object to provide a laser device capable of determining whether or not an optical element has actually deteriorated from a viewpoint of reducing the replacement frequency of the optical element.

### 3. First Embodiment

### 3.1 Configuration

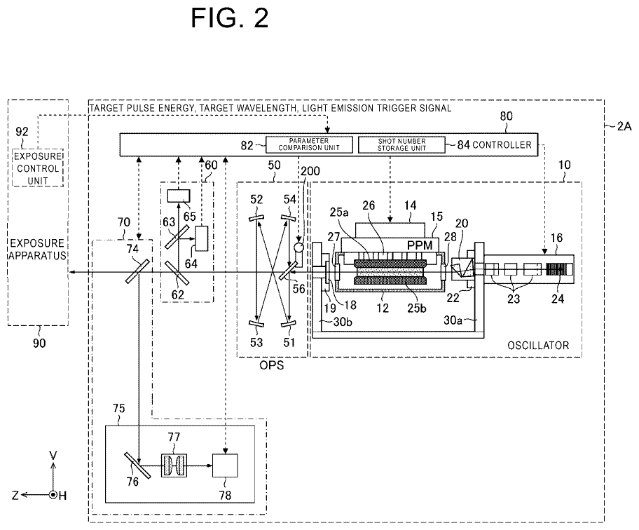

FIG. 2 schematically shows the configuration of a laser device 2A according to a first embodiment. The laser device 2A will be described in terms of differences from the laser device 2 shown in FIG. 1. The laser device 2A according to the first embodiment includes a slide mechanism 200 that moves the beam splitter 56 of the OPS 50. The beam splitter 56 is located immediately after the output coupling mirror 18, and the pulse laser light whose pulse width has not been extended is incident thereon. Therefore, the beam splitter 56 is one of the optical elements that is exposed to the laser light having a very high light intensity and that has a relatively high deterioration rate in the laser device 2A. Thus, it is preferable to provide the slide mechanism for the optical element having a relatively high deterioration rate among the plurality of optical elements arranged on the laser light path. In FIG. 2, an example in which the slide mechanism 200 is provided for the beam splitter 56 of the OPS 50 is shown, but not limited to this example, other optical elements arranged on the optical path of the laser light may be slidable.

Further, the controller 80 of the laser device 2A includes a parameter comparison unit 82 and a shot number storage unit 84. The parameter comparison unit 82 performs processing of comparing parameters calculated from output data of the beam measurement device 70 before and after movement of the beam splitter 56 by the slide mechanism 200.

The shot number storage unit 84 is a storage unit for recording the number of shots of the pulse laser light radiated to each usage part of the slidable optical element. The slidable optical element in the laser device 2A is the beam splitter 56. The “usage part” is a part of a region of the optical element, and is a region (portion) that is actually irradiated with the pulse laser light and used. The “usage part” may be replaced with a term such as “usage region”, “usage portion”, “usage position”, “beam irradiation position”. The usage part of the beam splitter 56 can be changed by moving the beam splitter 56 by the slide mechanism 200. The term “number of shots” may be replaced with the number of pulses.

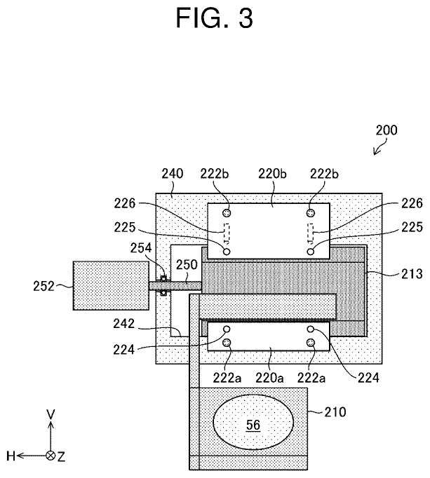

FIG. 3 schematically shows the configuration of the slide mechanism 200. FIG. 3 is a view viewed from a direction (Z direction) parallel to the optical path axis of the laser light transmitted through the beam splitter 56. The slide mechanism 200 is an example of the “movement mechanism” in the present disclosure.

The slide mechanism 200 includes a BS holder 210 that holds the beam splitter (BS) 56, a plate 213, plate holders 220a, 220b, a case 240, an actuator 252 including a rod 250, and an O-ring 254 as a rod seal.

The beam splitter 56 is fixed to the BS holder 210, and the BS holder 210 is fixed to the plate 213. The beam splitter 56 is arranged in a state in which an optical surface thereof on which the pulse laser light output from the oscillator 10 is incident is inclined by 45 degrees with respect to the optical path axis of the pulse laser light.

The case 240 is a container that accommodates the concave mirrors 51 to 54 of the OPS 50. In FIG. 3, only a part of the wall surface of the case 240 is shown.

The plate 213 is in contact with a case reference surface 242 and can be slid along the case reference surface 242 in the left-right direction (H direction) of FIG. 3. The case reference surface 242 is a reference surface provided on the case 240 and is a surface perpendicular to the V direction. The case reference surface 242 is a surface that defines a reference position of the beam splitter 56 in the V direction.

The plate holders 220a, 220b are fixed to the case 240 using bolts 222a, 222b to slidably hold the plate 213 in the H direction.

A plunger 224 acting in the Z direction is attached to the plate holder 220a. A plunger 225 acting in the Z direction and a plunger 226 acting in the V direction are attached to the plate holder 220b.

The plungers 224, 225 press the plate 213 against a reference surface (not shown) on the case 240 side. The plunger 226 presses the plate 213 against the case reference surface 242. Accordingly, the plate 213 is slidable in the H direction with the position in the V direction and the Z direction maintained. The H direction may be referred to as a slide direction.

The actuator 252 is arranged outside the case 240, and a force can be applied from the outside of the case 240 to the plate 213 via the rod 250 to move the plate 213 in the H direction. The rod 250 extending from the actuator 252 penetrates through a through hole formed in the case 240 and is connected to the plate 213. The O-ring 254 for sealing is arranged in the through hole to maintain airtightness in the case 240, and the rod 250 is movable in the H direction in contact with the O-ring 254.

The actuator 252 is connected to the controller 80 (see FIG. 2), and the actuator 252 is controlled by the controller 80. Driving the actuator 252 causes the rod 250 to move forward and backward in the H direction.

### 3.2 Operation

### 3.2.1 Slide Operation of Beam Splitter

The plate 213 slides in a direction perpendicular to the optical path axis (Z axis) and parallel to the optical surface (surface on which light is incident) of the beam splitter 56, so that an irradiation position of the laser light on the beam splitter 56 can be shifted while the orientation of the optical surface of the beam splitter 56 is maintained. The controller 80 drives the actuator 252 to slide the beam splitter 56 together with the plate 213 in the H direction. That is, a direction in which the beam splitter 56 is moved by the slide mechanism 200 is a direction along the surface of the beam splitter 56 on which the pulse laser light is incident.

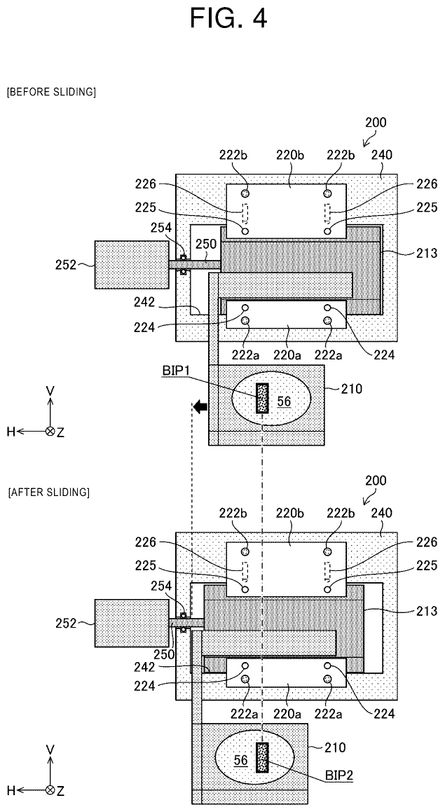

FIG. 4 is a view showing states before and after the beam splitter 56 is slid by the slide mechanism 200. The upper drawing of FIG. 4 is a view showing a state before sliding, that is, a state in which the beam splitter 56 is arranged at a first position. The lower drawing of FIG. 4 is a view showing a state after sliding, that is, a state in which the beam splitter 56 is arranged at a second position by the slide mechanism 200. Here, the descriptions of before sliding and after sliding are synonymous with before movement and after movement.

First, the beam splitter 56 is started to be used in a state of being arranged at the first position as shown in the upper drawing of FIG. 4. A region, of the beam splitter 56 arranged at the first position, where the pulse laser light is radiated is shown as a beam irradiation position BIP1. The beam irradiation position BIP1 is an example of the “first portion” in the present disclosure. For example, as shown in the upper drawing of FIG. 4, the beam irradiation position BIP1 is a portion on the left side with respect to the center of the beam splitter 56.

The beam splitter 56 is used in a state in which the pulse laser light is radiated to the beam irradiation position BIP1, and the controller 80 counts the number of shots to the beam irradiation position BIP1.

The controller 80 determines whether or not the beam irradiation position BIP1, which is the usage part of the beam splitter 56, has deteriorated after the number of shots increases.

At the time of the deterioration determination, the beam splitter 56 is moved from the first position to the second position as shown in the lower drawing of FIG. 4. A region, of the beam splitter 56 arranged at the second position, where the pulse laser light is radiated is shown as a beam irradiation position BIP2. The beam irradiation position BIP2 is an example of the “second portion” in the present disclosure. For example, as shown in the lower drawing of FIG. 4, the beam irradiation position BIP2 is a portion on the right side with respect to the center of the beam splitter 56. The beam irradiation position BIP2 is a portion that is used less frequently than the beam irradiation position BIP1 and can be regarded as a substantially unused portion. That is, whether or not a portion of the beam splitter 56 that is used frequently has deteriorated is determined by comparison with a portion that is used less frequently (a portion that has not deteriorated).

The deterioration determination operation in the laser device 2A is performed at a timing at which the laser light is not output to the exposure apparatus 90, for example, at the time of adjustment oscillation or at the time of periodic maintenance. The adjustment oscillation is operation of oscillating the laser light without outputting the laser light to the exposure apparatus 90 in order to adjust operation parameters of the laser device 2A. To perform laser oscillation without outputting the laser light to the exposure apparatus 90, the laser device 2A preferably includes a shutter (not shown) at an output portion thereof.

### 3.2.2 Operation Flow of Deterioration Determination

Deterioration determination operation in the laser device 2A is performed, for example, in the following procedure.

[Procedure 1] It is assumed that the number of shots of the pulse laser light radiated to the beam splitter 56 increases in the state before the plate 213 is slid. For example, it is assumed that the number of shots to the beam irradiation position BIP1 before sliding exceeds 30 billion pulses (Bpls).

[Procedure 2] The light intensity distribution of the pulse laser light at a beam cross section is measured by the beam measurement device 70 in the state of procedure 1. At this time, two-dimensional data I(x,y) of a light intensity of the pulse laser light, that is, an image showing the light intensity distribution is obtained from the image sensor 78. Since the beam measurement device 70 performs beam measurement of the pulse laser light propagating through the beam splitter 56, the state of the beam splitter 56 is reflected to the output data of the beam measurement device 70.

[Procedure 3] The plate 213 is slid by the actuator 252 and the beam irradiation position of the beam splitter 56 is shifted. For example, as shown in FIG. 4, the beam irradiation position is moved from the beam irradiation position BIP1 to the beam irradiation position BIP2.

[Procedure 4] It is assumed that the number of shots does not increase after the beam irradiation position is shifted. For example, it is assumed that the number of shots to the beam irradiation position BIP2 is 0 Bpls. In this state, the intensity distribution measurement unit 75 of the beam measurement device 70 measures the light intensity distribution of the pulse laser light at the beam cross section. At this time, the two-dimensional data I(x,y) of the light intensity of the pulse laser light, that is, an image showing the light intensity distribution is obtained from the image sensor 78.

[Procedure 5] The controller 80 compares parameters obtained from the images before and after the beam irradiation position is shifted to determine deterioration of the beam splitter 56 at the beam irradiation position BIP1, which is the usage part before sliding. The parameter obtained from each of the images is, for example, a parameter indicating the beam state such as a beam width (BPH, BPV) in each of the H direction and the V direction or a beam cross-sectional area. The controller 80 may calculate a plurality of parameters that serve as indicators in evaluating the beam quality. The deterioration determination of the beam splitter 56 is performed by the parameter comparison unit 82 based on the parameters calculated from the images before and after sliding.

[Procedure 6] When it is determined that the beam splitter 56 has deteriorated with respect to the beam irradiation position BIP1 before sliding as a result of the determination in procedure 5, the beam splitter 56 is started to be used at the beam irradiation position BIP2 after sliding. On the other hand, when it is not determined to have deteriorated with respect to the beam irradiation position BIP1 before sliding (when it is determined that it has not deteriorated) as a result of the determination in procedure 5, since continuation of use at the beam irradiation position BIP1 is possible, the beam splitter 56 is returned to the original position (first position) and use of the beam splitter 56 in a state in which the beam irradiation position BIP1 is irradiated with the pulse laser light is resumed.

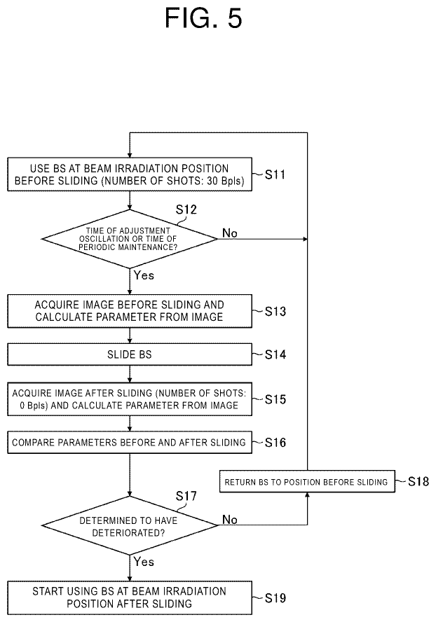

FIG. 5 is a flowchart showing an example of a deterioration determination method of the beam splitter 56.

In step S11, the beam splitter 56 is used at the beam irradiation position BIP1 before sliding. For example, the beam splitter 56 may continue to be used at the first position until the number of shots exceeds 30 Bpls.

In step S12, the controller 80 determines whether it is the time of adjustment oscillation or the time of periodic maintenance. When the determination result of step S12 is No, the controller 80 returns to step S11.

When the determination result of step S12 is Yes, the controller 80 proceeds to step S13. In step S13, the controller 80 acquires the image indicating the light intensity distribution of the beam before sliding from the beam measurement device 70, and calculates the parameter indicating the beam state from the image. The image acquired in step S13 is an example of the “first output data” in the present disclosure.

Here, for measuring the light intensity distribution of the beam by the beam measurement device 70, an output voltage at the time of laser oscillation may be set constant so that measurement can be performed with beams under the same condition before and after sliding. Further, the number of integrated pulses per image data may be constant, for example, 10 pulses integrated so that the measurement condition of the beam measurement device 70 becomes constant.

Then, in step S14, the controller 80 operates the actuator 252 to slide the beam splitter 56 to the second position. Then, in step S15, an image showing the light intensity distribution of the beam after sliding is acquired from the beam measurement device 70, and the parameter is calculated from the image. The image acquired in step S15 is an example of the “second output data” in the present disclosure.

The beam irradiation position BIP2 of the beam splitter 56 in this state after sliding (second position) is a portion that has obviously not deteriorated, and may be regarded as a substantially unused portion. Here, it is assumed that the number of shots to the beam irradiation position BIP2 is 0 Bpls. Not only a case in which the number of shots at the second position is zero, but also a case in which it is obvious that the number of shots does not lead to deterioration, for example, a case in which the number of shots less than 1 Bpls is counted is allowed. A calculation example of the parameter calculated from the output data of the beam measurement device 70 will be described later. In step S16, the controller 80 compares the parameters before and after sliding.

In step S17, the controller 80 determines whether or not deterioration has occurred based on the comparison result of step S16. When the determination result of step S17 is No, the controller 80 proceeds to step S18. In step S18, the controller 80 causes the beam splitter 56 to return to the position before sliding, and returns to step S11.

When the determination result of step S17 is Yes, the controller 80 proceeds to step S19. In step S19, the controller 80 starts using the beam splitter 56 at the beam irradiation position after sliding.

Here, although FIG. 5 shows the deterioration determination flow of the beam splitter 56, not limited to the beam splitter, similar deterioration determination may be performed for other optical elements such as the output coupling mirror 18 or the beam expander 20 by providing a slide mechanism thereto.

Not limited to the operation of the flowchart shown in FIG. 5, for example, the measurement of the cross-sectional intensity distribution of the laser light by the beam measurement device 70 may be performed in a state in which the laser light is output to the exposure apparatus 90 (the shutter of the output unit is in an open state). In such a case, the processes of step S13 and later in the flowchart shown in FIG. 5 may be performed at the time of adjustment oscillation or the like. Further, the parameter may be calculated during output of the laser light to the exposure apparatus 90, and when the parameter is equal to or less than a reference value, adjustment oscillation may be required to the exposure apparatus 90 and the deterioration determination may be performed at the time of adjustment oscillation to try to improve the parameter by sliding the optical element. Here, the reference value may be determined in advance by an experiment or the like.

### 3.3 Calculation Example of Parameter

### 3.3.1 Beam Width (BPH, BPV) in Each of H Direction and V Direction

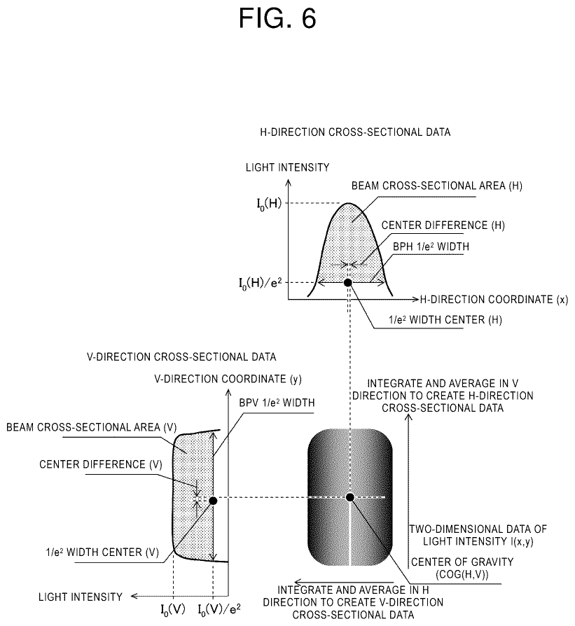

FIG. 6 is an explanatory diagram of a method for calculating the parameter from the two-dimensional data of the light intensity. The two-dimensional data of the light intensity I(x,y) shown at the center of FIG. 6 is an example of the image data acquired via the image sensor 78. Here, x is an H-direction coordinate and y is a V-direction coordinate.

First, the controller 80 creates cross-sectional data for calculating the beam width from the two-dimensional data of the light intensity I(x,y). The controller 80 integrates and averages the light intensity in the V direction in which the H-direction coordinates are the same to obtain H-direction cross-sectional data. Similarly, the light intensity in the H direction in which the V-direction coordinates are the same is integrated and averaged to obtain V-direction cross-sectional data.

Then, the width (1/e² width) of the light intensity at the height of 1/e² of the peak intensity in the cross-sectional data in each of the H direction and the V direction may be calculated. Here, e is Napier's constant. That is, a beam width BPH in the H direction may be the width of the light intensity at the height of 1/e² of a peak intensity I₀(H) of the H-direction cross-sectional data. Similarly, a beam width BPV in the V direction may be the width of the light intensity at the height of 1/e² of a peak intensity I₀(V) of the V-direction cross-sectional data.

Alternatively, the controller 80 may binarize the two-dimensional data of the optical intensity I(x,y) based on a predetermined intensity, and measure the widths in the H direction and the V direction.

### 3.3.2 Beam Cross-Sectional Area

The controller 80 may calculate an area of a region at which the light intensity is equal to or larger than 1/e² of the peak intensity and equal to or smaller than the peak intensity in the cross-sectional data in the H direction and the V direction, and may set the calculated area as the beam cross-sectional area. Further, a certain proportion of the peak intensity, for example, the width and area of the light intensity of 5% to 10% with respect to the peak intensity may be calculated. Alternatively, the two-dimensional data may be binarized based on the predetermined intensity to calculate the beam cross-sectional area.

### 3.3.3 Difference Between Center of Gravity and Center of Beam Width (Center Difference)

The controller 80 may calculate the center of gravity (COG) in the respective directions of the H direction and the V direction from the light intensity I(x,y), which is the two-dimensional data, with the coordinate in the H direction being x and the coordinate in the V direction being y. The center of gravity COG(H) in the H direction and the center of gravity COG(V) in the V direction are defined by the following expressions of [Expression 1] and [Expression 2].

$$COG ( H ) = \frac{\int \int I ( x , y ) * xdxdy}{\int \int I ( x , y ) dxdy} \qquad [ Expression 1 ]$$

$$COG ( V ) = \frac{\int \int I ( x , y ) * ydxdy}{\int \int I ( x , y ) dxdy} \qquad [ Expression 2 ]$$

Further, the controller 80 may calculate a center difference in the H direction from the difference between the center of gravity COG(H) in the H direction and a center position of the beam width BPH in the H direction. Similarly, the controller 80 may calculate a center difference in the V direction from the difference between the center of gravity COG(V) in the V direction and a center position of the beam width BPV in the V direction.

### 3.4 Example of Deterioration Determination

### 3.4.1 Example of Deterioration Determination Based on Beam Width

In an example of the deterioration determination method applied to step S16 and step S17, a value α used for a determination condition may be set to a value larger than 1, and the portion (beam irradiation position BIP1) of the beam splitter 56 which is the usage part before sliding is determined to have been deteriorated when the beam width before sliding is larger than α times the beam width after sliding.

For example, the controller 80 may determine that deterioration has occurred when both of the following expressions (1) and (2) are satisfied. Here, α in the expressions may be, for example, 1.05.

$$BPH before sliding > BPH after sliding \times α \qquad ( 1 )$$

$$BPV before sliding > BPV after sliding \times α \qquad ( 2 )$$

BPH before sliding and BPH after sliding are examples of “BPH1” and “BPH2” in the present disclosure, respectively. BPV before sliding and BPV after sliding are examples of “BPV1” and “BPV2” in the present disclosure, respectively.

### 3.4.2 Example of Deterioration Determination Based on Beam Cross-Sectional Area

In another example of the deterioration determination method applied to step S16 and step S17, a value β used for the determination condition may be set to a value smaller than 1, and the portion of the beam splitter 56 which is the usage part before sliding is determined to have been deteriorated when the beam cross-sectional area calculated from the image before sliding is smaller than β times the beam cross-sectional area calculated from the image after sliding. That is, the controller 80 may determine that deterioration has occurred when the following expression (3) is satisfied.

$$beam cross - sectional area before sliding < beam cross - sectional area after sliding \times B \qquad ( 3 )$$

Here, β in the expression may be, for example, 0.90.

### 3.4.3 Example of Deterioration Determination Based on Difference Between Center of Gravity and Beam Width Center (Center Difference)

In another example of the deterioration determination method applied to step S16 and step S17, a value γ used for the determination condition may be set to a value larger than 0, and the portion of the beam splitter 56 which is the usage part before sliding is determined to have been deteriorated when an absolute value of a difference between the center difference calculated from the image before sliding and the center difference calculated from the image after sliding is larger than γ. That is, the controller 80 may determine that deterioration has occurred when the following expression (4) is satisfied.

$$\vert center difference before sliding - center difference after sliding \vert > γ \qquad ( 4 )$$

Here, γ in the expression may be, for example, 0.5 mm.

### 3.5 Effect

As described above, in the laser device 2A according to the first embodiment, an optical element having a relatively high deterioration rate is specified in advance, and the slide mechanism 200 is provided to the optical element (here, the beam splitter 56). Then, the parameters before and after sliding are calculated from the light intensity distribution of the beam obtained by the beam measurement device 70, and the deterioration portion in the optical element can be specified by comparing the parameter. Therefore, according to the first embodiment, the following effects are obtained.

[1] Since it is possible to determine whether or not the radiation region (usage part) of the pulse laser light in the optical element has actually deteriorated, unnecessary element replacement due to a set lifetime determined uniformly in advance can be suppressed.

[2] By specifying a deterioration portion among usable regions of the optical element and using another portion while avoiding the deteriorated portion, it is possible to extend the lifetime of the optical element and maintain the performance of the laser.

Further, the laser device 2A according to the first embodiment has the following advantages also over the conventional technology in which a state (presence or absence of deterioration) of an optical element in the laser device 2 is determined by acquiring image data representing a state of a beam and performing template matching with image data representing a known deterioration mode.

[3] Deterioration of the optical element can be determined without image data representing a known deterioration mode.

[4] Deterioration determination can be performed while taking an image difference due to individual differences of optical elements into account.

[5] By comparing with different positions of the same optical element, comparison failure is reduced than by comparing with a known image of an optical element different from the optical element being the determination target.

### 3.6 Others

In the first embodiment, an example in which two portions being the beam irradiation position BIP1 and the beam irradiation position BIP2 are assumed as the usage portions of the beam splitter 56 has been described, but the usage portions in the region of the optical element are not limited to two portions, and may be three or more portions.

### 4. Second Embodiment

### 4.1 Configuration

Although an example in which the slide mechanism 200 is provided to the beam splitter 56 of the OPS 50 has been described in the first embodiment, the present invention is not limited thereto, and slide mechanisms may be provided to a plurality of optical elements, respectively.

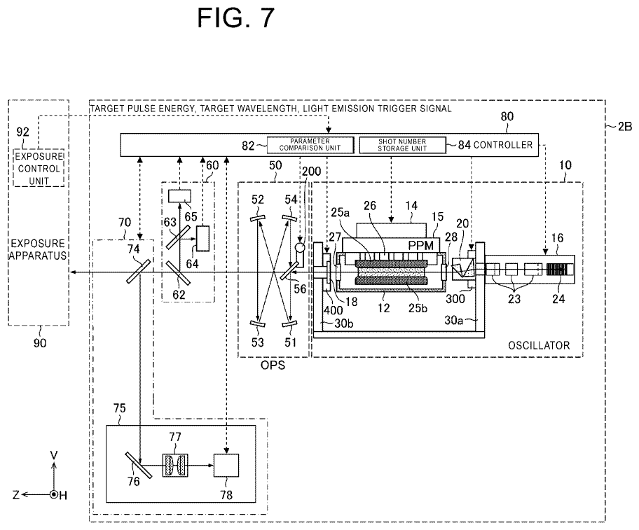

FIG. 7 schematically shows the configuration of a laser device 2B according to a second embodiment. The laser device 2B according to the second embodiment will be described in terms of differences from the first embodiment.

The laser device 2B shown in FIG. 7 has a configuration in which slide mechanisms 300, 400 with actuators are added to the beam expander 20 and the output coupling mirror 18, respectively. That is, the slide mechanism 300 is provided instead of the mount 22 shown in FIG. 2, and the slide mechanism 400 is provided instead of the base 19. The respective actuators of the slide mechanism 300 and the slide mechanism 400 are connected to the controller 80. Other configurations may be similar to those of the first embodiment.

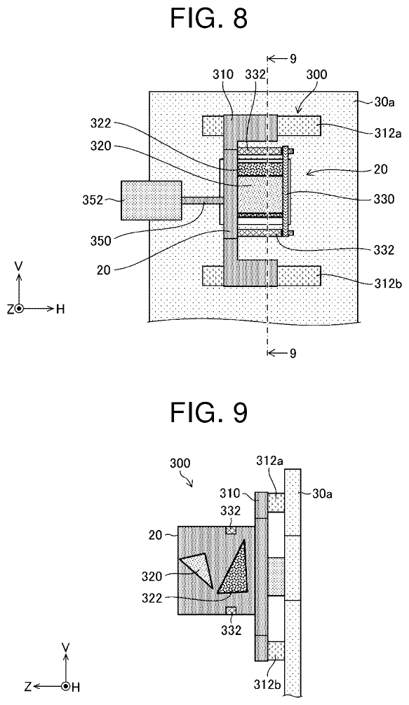

FIG. 8 is a plan view schematically showing the configuration of the beam expander 20 to which the slide mechanism 300 is added. FIG. 9 is a sectional view taken along line 9-9 of FIG. 8.

The beam expander 20 including the slide mechanism 300 includes a prism base 310, linear guides 312a, 312b, prisms 320, 322, a pressing plate 330, a support column 332, and an actuator 352 including a rod 350. The prism base 310 is held by the linear guides 312a, 312b arranged parallel to each other on the cavity plate 30a. The linear guides 312a, 312b are arranged parallel along the H direction and are fixed on the cavity plate 30a.

The relative positions of the prisms 320, 322 are defined by being sandwiched between the prism base 310 and the pressing plate 330. The prism base 310 and the pressing plate 330 are coupled to each other via the support column 332. The actuator 352 slides the prism base 310 in the left-right direction (H direction) in FIG. 8 via the rod 350. The actuator 352 is connected to the controller 80.

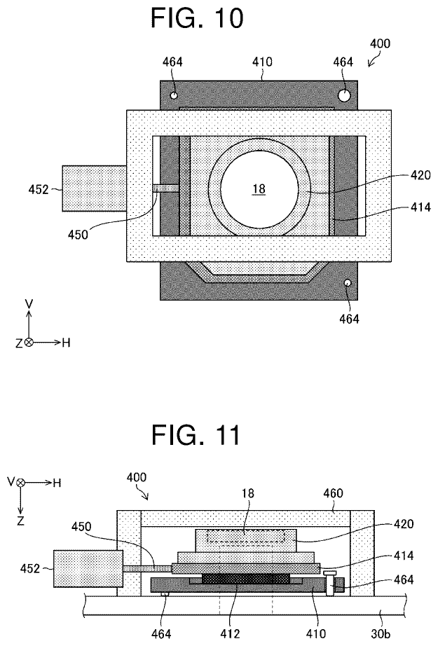

FIG. 10 is a plan view schematically showing the configuration of the output coupling mirror 18 to which the slide mechanism 400 is added. FIG. 11 is a side view including a partial section of FIG. 10 viewed from the V direction.

The output coupling mirror 18 including the slide mechanism 400 includes an output coupling mirror base 410, a slide guide 412, a mirror holder mounting base 414, a mirror holder 420, an actuator 452 including a rod 450, and a case 460.

The mirror holder 420 holding the output coupling mirror 18 is fixed to the mirror holder mounting base 414. The mirror holder mounting base 414 is held by the slide guide 412 fixed on the output coupling mirror base 410 and is connected to the rod 450 of the actuator 452 arranged along the H direction.

The actuator 452 is fixed to the case 460 positioned on the cavity plate 30b. The case 460 includes a through hole through which the rod 450 penetrates. By pushing and pulling the mirror holder mounting base 414 in the H direction by the actuator 452, the mirror holder mounting base 414 can be translated in the H direction along the output coupling mirror base 410. The actuator 452 is connected to the controller 80.

The output coupling mirror base 410 may be fixed to the cavity plate 30b by three adjustment screws 464, and the angle thereof with respect to the cavity plate 30b may be changed by adjusting screwing amounts of the respective adjustment screws 464.

### 4.2 Operation

### 4.2.1 Slide Operation of Beam Expander

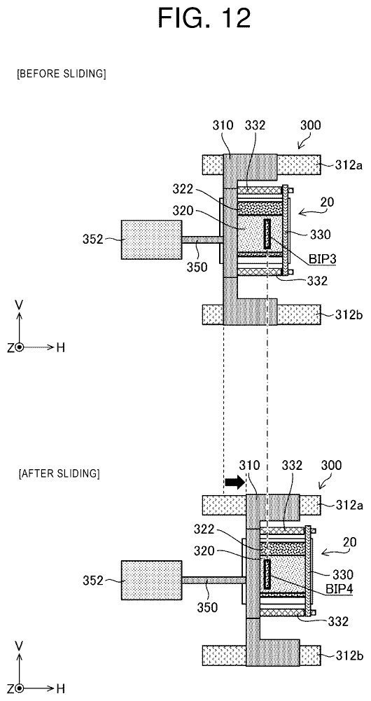

FIG. 12 is a view showing states before and after the beam expander 20 is slid by the slide mechanism 300. The upper drawing of FIG. 12 shows a state before sliding, and the lower drawing shows a state after sliding. The slide mechanism 300 slides the prism base 310 in a direction parallel to the surface of the beam expander 20 on which the light is incident by driving the actuator 352, so that the irradiation position of the laser light on the beam expander 20 can be shifted while maintaining the orientation of the surface of the beam expander 20 on which the light is incident. The controller 80 slides the beam expander 20 in the H direction together with the prism base 310 by driving the actuator 352.

First, the beam expander 20 is started to be used in a state of being arranged at the first position as shown in the upper drawing of FIG. 12. A region, of the beam expander 20 arranged at the first position, where the pulse laser light is radiated is shown as a beam irradiation position BIP3. The beam irradiation position BIP3 is an example of the “first portion” in the present disclosure. The beam expander 20 is used in a state in which the pulse laser light is radiated to the beam irradiation position BIP3, and the controller 80 counts the number of shots to the beam irradiation position BIP3.

The controller 80 determines whether or not the beam irradiation position BIP3, which is the usage part of the beam expander 20, has deteriorated after the number of shots increases. At the time of the deterioration determination, the beam expander 20 is moved from the first position to the second position as shown in the lower drawing of FIG. 12. A region, of the beam expander 20 arranged at the second position, where the pulse laser light is radiated is shown as a beam irradiation position BIP4. The beam irradiation position BIP4 is an example of the “second portion” in the present disclosure. The beam irradiation position BIP4 is a portion that is used less frequently than the beam irradiation position BIP3 and can be regarded as a substantially unused portion.

The deterioration determination method may be similar to that of the first embodiment. When it is determined that the beam expander 20 has deteriorated with respect to the beam irradiation position BIP3 before sliding as a result of the determination, the beam expander 20 is used at the beam irradiation position BIP4 after sliding. On the other hand, when it is not determined to have deteriorated with respect to the beam irradiation position BIP3 before sliding as a result of the determination, the beam expander 20 is returned to the original position and use of the beam expander 20 in a state in which the beam irradiation position BIP3 is irradiated with the pulse laser light is resumed.

### 4.2.2 Slide Operation of Output Coupling Mirror

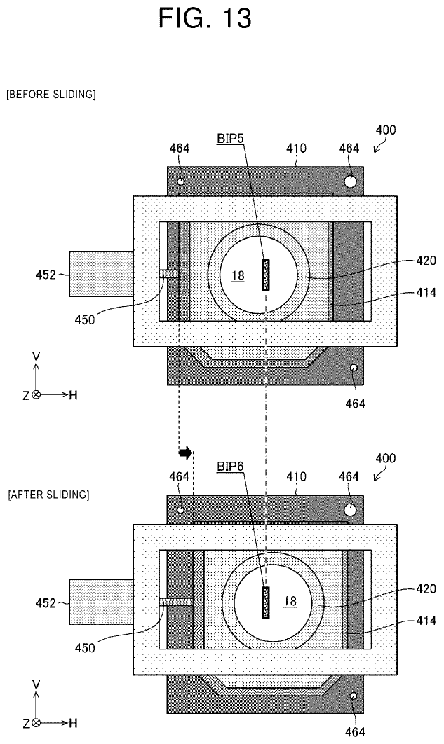

FIG. 13 is a view showing states before and after the output coupling mirror 18 is slid by the slide mechanism 400. The upper drawing of FIG. 13 is a view showing a state before sliding. The lower view of FIG. 13 is a view showing a state after sliding. The slide mechanism 400 slides the mirror holder mounting base 414 in a direction parallel to the surface of the output coupling mirror 18 on which the light is incident by driving the actuator 452, so that the irradiation position of the laser light on the output coupling mirror 18 can be shifted while maintaining the orientation of the surface of the output coupling mirror 18 on which the light is incident. The controller 80 slides the output coupling mirror 18 in the H direction together with the mirror holder mounting base 414 by driving the actuator 452.

First, the output coupling mirror 18 is started to be used in a state of being arranged at the first position as shown in the upper drawing of FIG. 13. A region, of the output coupling mirror 18 arranged at the first position, where the pulse laser light is radiated is shown as a beam irradiation position BIP5.

Similarly to the case of the beam expander 20, at the time of the deterioration determination for the output coupling mirror 18 as well, the output coupling mirror 18 is moved from the first position to the second position as shown in the lower drawing of FIG. 13. A region, of the output coupling mirror 18 arranged at the second position, where the pulse laser light is radiated is shown as a beam irradiation position BIP6.

When it is determined that the output coupling mirror 18 has deteriorated with respect to the beam irradiation position BIP5 before sliding as a result of the deterioration determination, the output coupling mirror 18 is used at the beam irradiation position BIP6 after sliding. On the other hand, when it is not determined to have deteriorated with respect to the beam irradiation position BIP5 before sliding as a result of the determination, the output coupling mirror 18 is returned to the original position and use is resumed.

### 4.2.3 Operation Flow of Deterioration Determination

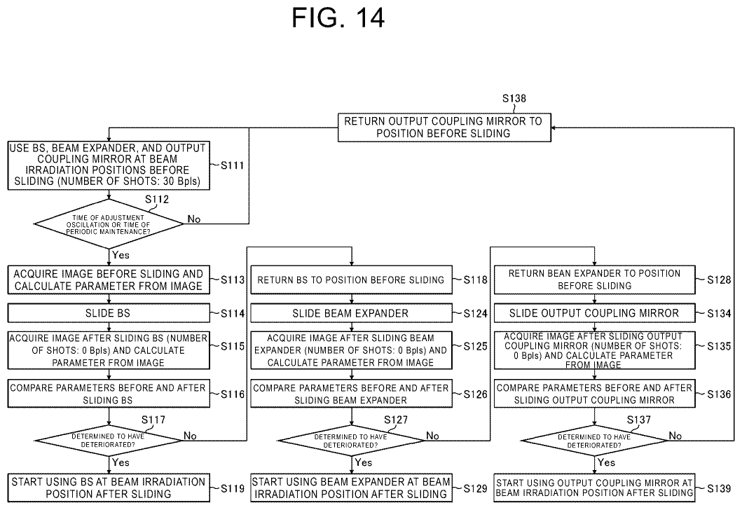

FIG. 14 is a flowchart showing an example of the deterioration determination method of the optical element in the laser device 2B according to the second embodiment. Here, a case in which target optical elements are the beam splitter 56, the beam expander 20, and the output coupling mirror 18 will be exemplified.

In step S111, each of the beam splitter 56, the beam expander 20, and the output coupling mirror 18 is used at the beam irradiation position before sliding. For example, the beam splitter 56, the beam expander 20, and the output coupling mirror 18 may continue to be used at the respective first positions until the number of shots exceeds 30 Bpls.

The steps from step S112 to step S119 may be similar to those from step S12 to step S19 of FIG. 5. However, in the flowchart of FIG. 14, the controller 80 proceeds to step S124 after returning the beam splitter 56 to the position before sliding in step S118, which is different from step S18 of FIG. 5.

In step S124, the controller 80 slides the beam expander 20. Then, in step S125, an image showing the light intensity distribution of the beam after the beam expander 20 is slid is acquired from the beam measurement device 70, and the parameter is calculated from the image. The beam irradiation position BIP4 of the beam expander 20 in this state after sliding (second position) is a portion that has obviously not deteriorated, and may be regarded as a substantially new portion. Here, it is assumed that the number of shots to the beam irradiation position BIP4 is, for example, 0 Bpls.

In step S126, the controller 80 compares the parameters before and after sliding the beam expander 20.

In step S127, the controller 80 determines whether or not the beam expander 20 has deteriorated. The deterioration determination method may be similar to the case of the beam splitter 56. When the determination result of step S127 is Yes, the controller 80 proceeds to step S129. In step S129, the controller 80 starts using the beam expander 20 at the beam irradiation position after sliding.

When the determination result of step S127 is No, the controller 80 proceeds to step S128.

After returning the beam expander 20 to the position before sliding in step S128, the controller 80 proceeds to step S134.

In step S134, the controller 80 slides the output coupling mirror 18. Then, in step S135, an image showing the light intensity distribution of the beam after sliding is acquired from the beam measurement device 70, and the parameter is calculated from the image.

In step S136, the controller 80 compares the parameters before and after sliding the output coupling mirror 18.

In step S137, the controller 80 determines whether or not the output coupling mirror 18 has deteriorated. The deterioration determination method may be similar to the case of the beam splitter 56. When the determination result of step S137 is Yes, the controller 80 proceeds to step S139. In step S139, the controller 80 starts using the output coupling mirror 18 at the beam irradiation position BIP6 after sliding.

When the determination result of step S137 is No, the controller 80 proceeds to step S138.

After returning the output coupling mirror 18 to the position before sliding in step S138, the controller 80 returns to step S111.

### 4.3 Effect

In the second embodiment, sliding is performed in the order of [1] the beam splitter 56, [2] the beam expander 20, and [3] the output coupling mirror 18. This is due to the following reasons. That is, the deterioration rate of the optical element is considered to be dependent on an energy load, and the energy load is considered to be higher in the optical resonator. The beam splitter 56 is an optical element arranged downstream of the optical resonator, while the beam expander 20 and the output coupling mirror 18 are optical elements arranged in the optical resonator. That is, the energy load of the beam splitter 56 is considered to be the lowest among the three optical elements. Further, when the beam expander 20 and the output coupling mirror 18 are compared, since the reflectance of the output coupling mirror 18 is about 20%, it is considered that the energy load applied to the output coupling mirror 18 is higher than that applied to the beam expander 20.

In the second embodiment, the deterioration determination is performed by sliding the plurality of slidable optical elements (the beam splitter 56, the beam expander 20, and the output coupling mirror 18) in order from the element having a lower deterioration rate. Since the deterioration determination of the optical element which is considered to have a higher deterioration rate among the slidable optical elements is performed later, usable optical elements can be specified sequentially.

Here, in FIG. 14, an example in which the deterioration determination is performed on the optical elements of the beam splitter 56, the beam expander 20, and the output coupling mirror 18 has been described, but when it is determined that deterioration has occurred at the optical element having a lower energy load and the number of used shots is the same, it can be considered that there is a high possibility that the optical element having a higher energy load has also deteriorated. Therefore, for an optical element having a higher energy load, it is also possible to change the usage position by sliding the optical element without performing the deterioration determination together with the optical element whose deterioration has been confirmed.

For example, in step S119, since the beam expander 20 and the output coupling mirror 18 are likely to have deteriorated as well as the beam splitter 56, the controller 80 may also slide the beam expander 20 and the output coupling mirror 18 together to start use of the optical elements at the beam irradiation positions BIP4, BIP6 after sliding.

Further, for example, in step S129, since the output coupling mirror 18 is likely to have deteriorated as well as the beam expander 20, the controller 80 may also slide the output coupling mirror 18 together to start use at the beam irradiation position BIP6 after sliding.

As described above, according to the second embodiment, the following effects can be expected.

[1] By sliding a plurality of optical elements that may have deteriorated, the deteriorated element can be specified to some extent.

[2] It is possible to extend the lifetime of the optical elements and maintain the performance of the laser by specifying deteriorated portions of the plurality of optical elements arranged on the laser light path and using the optical elements while avoiding the deteriorated portions.

### 5. Third Embodiment

### 5.1 Configuration

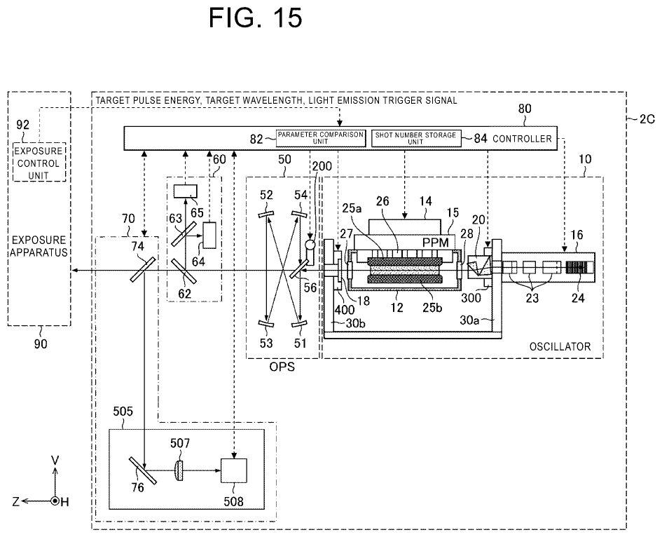

FIG. 15 schematically shows the configuration of a laser device 2C according to a third embodiment. The configuration of the laser device 2C will be described in terms of differences from the laser device 2B (FIG. 7) according to the second embodiment.

The laser device 2C includes a beam divergence angle measurement unit 505 instead of the intensity distribution measurement unit 75 in the beam measurement device 70. The beam divergence angle measurement unit 505 includes a high reflection mirror 76, a light concentrating optical system 507, and an image sensor 508.

The light concentrating optical system 507 includes a lens, and is arranged on the optical path of the reflection light of the high reflection mirror 76. The focal length of the light concentrating optical system 507 is represented by F.

The image sensor 508 is a camera including two-dimensional CCD elements, and the CCD elements may be arranged at a position of an image where a laser beam is concentrated by the light concentrating optical system 507.

The controller 80 is connected to a control signal line of an electronic shutter of the image sensor 508 so as to transmit a trigger signal of the electronic shutter of the image sensor 508 in synchronization with the light emission trigger signal from the exposure apparatus 90. Other configurations may be similar to those of the laser device 2B shown in FIG. 7. Here, instead of the slide mechanisms 300, 400, the base 19 and the mount 22 may be used as in the laser device 2A shown in FIG. 2.

### 5.2 Operation

The controller 80 outputs the trigger signal to the electronic shutter of the image sensor 508 in synchronization with the light emission trigger signal, and acquires image data from the image sensor 508. The controller 80 obtains the beam divergence angle as the parameter from the image data of the image sensor 508.

The flowchart shown in FIG. 5 is similarly applied to the laser device 2C according to the third embodiment. However, in the laser device 2C, the parameter to be calculated in step S15 to step S17 and the deterioration determination method using the parameter are different from those in the laser device 2A of the first embodiment.

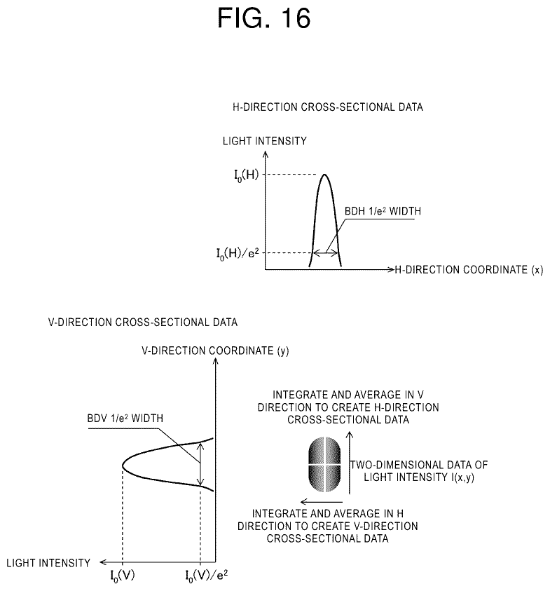

FIG. 16 is an explanatory diagram of a method for calculating the parameter from the two-dimensional data of the light intensity obtained from the image sensor 508. The two-dimensional data of the light intensity I(x,y) shown at the center of FIG. 16 is an example of the image data acquired via the image sensor 508.

First, the controller 80 creates cross-sectional data for calculating the beam divergence angle from the two-dimensional data of the light intensity I(x,y). The controller 80 integrates and averages the light intensity in the V direction in which the H-direction coordinates are the same to obtain H-direction cross-sectional data. Similarly, the light intensity in the H direction in which the V-direction coordinates are the same is integrated and averaged to obtain V-direction cross-sectional data.

Then, as shown in FIG. 16, the width (1/e² width) of the light intensity at the height of 1/e² of the peak intensity in the cross-sectional data of each of the H direction and the V direction may be calculated. That is, a beam width Wh in the H direction may be the width of the light intensity at the height of 1/e² of the peak intensity I₀(H) of the H-direction cross-sectional data. Similarly, a beam width Wv in the V direction may be the width of the light intensity at the height of 1/e² of the peak intensity I₀(V) of the V-direction cross-sectional data.

Alternatively, the controller 80 may binarize the two-dimensional data of the optical intensity I(x,y) based on a predetermined intensity, and measure the widths in the H direction and the V direction.

The beam divergence angle (θ) may be calculated by the following expression (5) using the width (W) of the light intensity calculated by the above-described method and the focal length (F) of the lens of the light concentrating optical system 507.

$$θ = 2 \times {tan}^{- 1} ( 0 \text{.5} \times W / F ) \qquad ( 5 )$$

That is, the beam divergence angle BDH in the H direction and the beam divergence angle BDV in the V direction may be calculated by the following expressions (6) and (7), respectively.

$$BDH = 2 \times {tan}^{- 1} ( 0 \text{.5} \times W h / F ) \qquad ( 6 )$$

$$BDV = 2 \times {tan}^{- 1} ( 0 \text{.5} \times Wv / F ) \qquad ( 7 )$$

### 5.3 Example of Deterioration Determination

In an example of the deterioration determination method applied to step S16 and step S17 using the beam divergence angle (BDH, BDV) in each of the H direction and the V direction, the value a used for the determination condition may be set to a value larger than 1, and the portion (beam irradiation position BIP1) of the beam splitter 56 which is the usage part before sliding is determined to have been deteriorated when the beam divergence angle before sliding is larger than a times the beam divergence angle after sliding.

For example, the controller 80 may determine that deterioration has occurred when both of the following expressions (8) and (9) are satisfied. Here, a in the expression may be, for example, 1.05.

$$BDH before sliding > BDH after sliding \times α \qquad ( 8 )$$

$$BDV before sliding > BDV after sliding \times α \qquad ( 9 )$$

BDH before sliding and BDH after sliding are examples of “BDH1” and “BDH2” in the present disclosure, respectively. BDV before sliding and BDV after sliding are examples of “BDV1” and “BDV2” in the present disclosure, respectively.

### 5.4 Effect

The effects of the laser device 20 according to the third embodiment are similar to those of the first embodiment.

### 5.5 Others

Although FIG. 5 shows the deterioration determination flow of the beam splitter 56, the deterioration determination based on the beam divergence angles (BDH, BDV) may be performed on the beam expander 20 or the output coupling mirror 18. Further, in the laser device 2C, a similar flowchart as in the second embodiment (FIG. 14) may be applied.

### 5.6 First Modification

### 5.6.1 Configuration

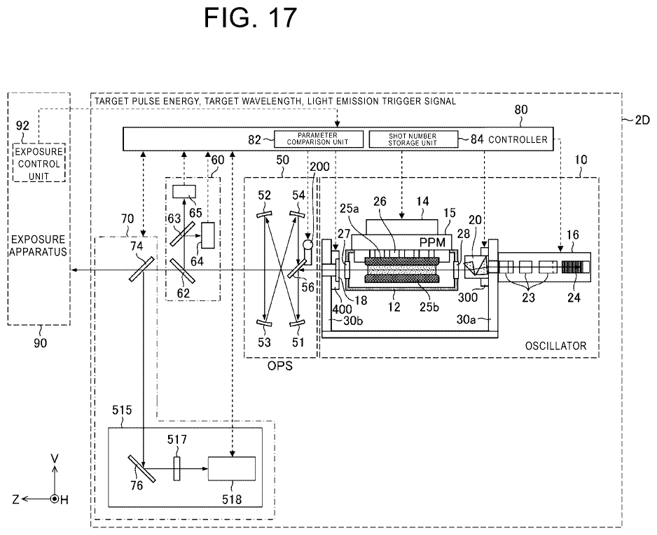

FIG. 17 schematically shows the configuration of a laser device 2D according to a first modification of the third embodiment. The laser device 2D will be described in terms of differences from the laser device 2C (FIG. 15) according to the third embodiment.

The laser device 2D includes a pulse time-width measurement unit 515 instead of the beam divergence angle measurement unit 505 in the beam measurement device 70. The pulse time-width measurement unit 515 includes the high reflection mirror 76, a diffusion plate 517, and a biplanar photoelectric tube 518.

The diffusion plate 517 is arranged on the optical path of the reflection light of the high reflection mirror 76. The biplanar photoelectric tube 518 is arranged at a position after the laser beam is diffused by the diffusion plate 517. The controller 80 is connected to a control signal line of an electronic shutter of the biplanar photoelectric tube 518 so as to transmit a trigger signal of the electronic shutter of the biplanar photoelectric tube 518 in synchronization with the light emission trigger signal from the exposure apparatus 90. Other configurations may be similar to those of the laser device 2B shown in FIG. 7. Here, instead of the slide mechanisms 300, 400, the base 19 and the mount 22 may be used as in the laser device 2A shown in FIG. 2.

### 5.6.2 Operation

The controller 80 outputs the trigger signal to the electronic shutter of the biplanar photoelectric tube 518 in synchronization with the light emission trigger signal from the exposure apparatus 90, and acquires a light intensity time waveform from the biplanar photoelectric tube 518. The controller 80 obtains the pulse time width of the beam from the light intensity time waveform (pulse waveform) of the pulse laser light.

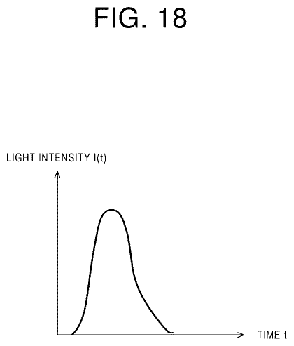

FIG. 18 is an example of the pulse waveform obtained by the biplanar photoelectric tube 518. The horizontal axis represents time, and the vertical axis represents the light intensity. Examples of the pulse waveform include a time distribution of the light intensity of the beam. When the light intensity of the beam at a certain time t is I(t), the pulse time width as the time integral square (TIS) is calculated by the following [Expression 3] using the square of the time integral value of the light intensity I(t) and the time integral value of the square of the light intensity I(t).

$$TIS = \frac{{( \int I ( t ) dt )}^{2}}{\int {I}^{2} ( t ) d t} \qquad [ Expression 3 ]$$

The pulse time width calculated as the TIS is an example of the parameter calculated from the pulse waveform which is the output data of the beam measurement device 70.

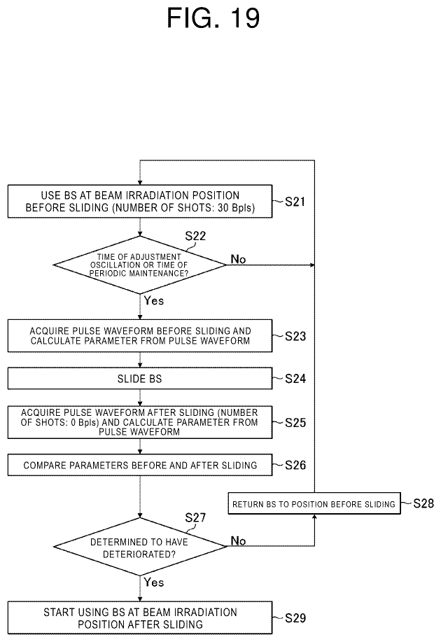

FIG. 19 is a flowchart showing an example of the deterioration determination method of the beam splitter 56 based on the pulse time width. Step S21 and step S22 of FIG. 19 are similar to step S11 and step S12 of FIG. 5.

In step S23, the controller 80 acquires the pulse waveform before sliding from the beam measurement device 70, and calculates the parameter from the pulse waveform. Here, the TIS as the parameter is calculated.

Step S24 is similar to step S14 of FIG. 5, and the controller 80 drives the actuator 252 to slide the beam splitter 56. In step S25, the controller 80 acquires the pulse waveform after sliding from the beam measurement device 70, and calculates the parameter from the pulse waveform.

Thus, the TIS before sliding is calculated in step S23, and the TIS after sliding is calculated in step S25.

Then, in step S26, the controller 80 compares the parameters before and after sliding. In step S27, for example, when the following expression (10) is satisfied, the controller 80 may determine that the usage part before sliding has deteriorated. Here, β in the expression may be, for example, 0.9.

$$TIS before sliding < TIS after sliding \times β \qquad ( 10 )$$

Step S28 and step S29 are similar to step S18 and step S19 of FIG. 5.

### 5.6.3 Effect

According to the laser device 2D of the first modification of the third embodiment, similar effects can be obtained as the first embodiment.

### 5.7 Second Modification

### 5.7.1 Configuration

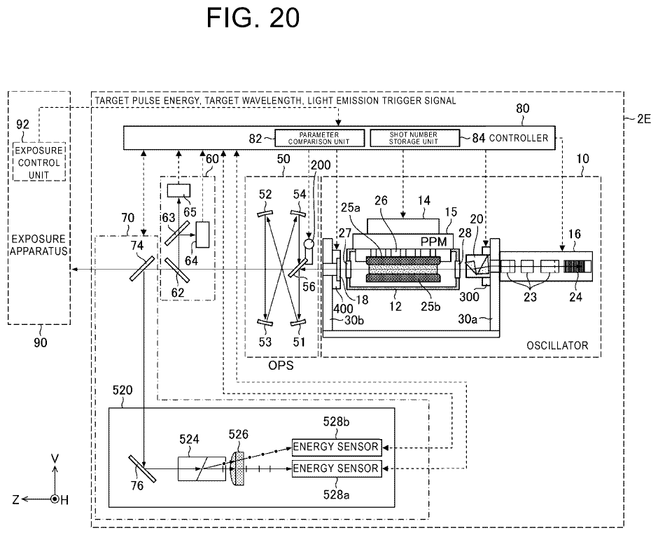

FIG. 20 schematically shows the configuration of a laser device 2E according to a second modification of the third embodiment. The laser device 2E will be described in terms of differences from the laser device 2C (FIG. 15) according to the third embodiment.

The laser device 2E includes a polarization measurement unit 520 instead of the beam divergence angle measurement unit 505 in the beam measurement device 70. The polarization measurement unit 520 includes the high reflection mirror 76, a Rochon prism 524, a light concentrating optical system 526, and energy sensors 528a, 528b.

The Rochon prism 524 and the light concentrating optical system 526 are arranged on the optical path of the reflection light of the high reflection mirror 76. The energy sensors 528a, 528b are arranged so as to be able to separately receive light of an H-direction polarization component and light of a V-direction polarization component separated by the Rochon prism 524.

The controller 80 is connected to control signal lines of electronic shutters of the energy sensors 528a, 528b so as to transmit a trigger signal of each of the electronic shutters of the energy sensors 528a, 528b in synchronization with the light emission trigger signal from the exposure apparatus 90. Other configurations may be similar to those of the laser device 2B shown in FIG. 7. Here, instead of the slide mechanisms 300, 400, the base 19 and the mount 22 may be used as in the laser device 2A shown in FIG. 2.

### 5.7.2 Operation

When the light emission trigger signal is input to the controller 80, pulse laser light is output: from the oscillator 10, and the pulse laser light is incident on the Rochon prism 524 via the beam splitters 56, 62, 74 and the high reflection mirror 76.

In the Rochon prism 524, the light of the V-direction polarization component travels straight, is concentrated by the light concentrating optical system 526, and is incident on the light receiving element of the energy sensor 528a. On the other hand, the light of the H-direction polarization component is refracted, is concentrated by k the light concentrating optical system 526, and is incident on the light receiving element of the energy sensor 528b. The V direction is an example of the “first direction” in the present disclosure, and the H direction is an example of the “second direction” in the present disclosure.

Energy data Pv obtained from the energy sensor 528a and energy data Ph obtained from the energy sensor 528b are input to the controller 80. The controller 80 integrates the values of Ph and Pv during burst oscillation (Phsum, Pvsum), respectively, and when burst is paused, the controller 80 obtains a polarization degree P from the following expression (11) based on the respective integrated values Phsum, Pvsum.

$$P = ( Phsum - Pvsum ) / ( Phsum + Pvsum ) \qquad ( 11 )$$

The polarization degree P may be used for the deterioration determination of an element as a parameter to be an index in the deterioration determination instead of the beam width or the beam divergence angle.

For example, the controller 80 may determine that deterioration has occurred when the following expression (12) is satisfied. Here, δ in the expression is a value smaller than 1, and may be, for example, 0.98.

$$P before sliding < P after sliding \times δ \qquad ( 12 )$$

Other operation may be similar to the flow of the flowchart of FIG. 5 or FIG. 14. Here, the output data of the beam measurement device 70 is the energy data Pv, Ph of the energy sensors 528a, 528b, and the parameter is the polarization degree P. is, That the deterioration determination based on the polarization degree P may be performed not only for the beam splitter 56, but also for the beam expander 20 or the output coupling mirror 18.

### 5.7.3 Effect

The Rochon prism 524 separates the pulse laser light into the light of the V-direction polarization component and the light of the H-direction polarization component, and can measure the polarization degree P even when the energies of the polarization components are detected separately by the energy sensors 528a, 528b. According to the laser device 2E of the second modification, similar effects can be obtained as the first embodiment and the second embodiment.

### 6. Fourth Embodiment

### 6.1 Configuration

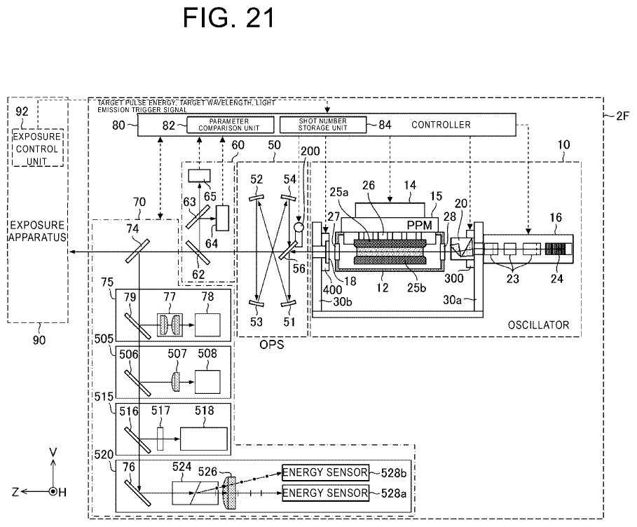

FIG. 21 schematically shows the configuration of a laser device 2F according to a fourth embodiment. The laser device 2F will be described in terms of differences from the laser device 2C (FIG. 15) according to the third embodiment. The beam measurement device 70 of the laser device 2F may include a plurality of measurement units among the intensity distribution measurement unit 75, the beam divergence angle measurement unit 505, the pulse time-width measurement unit 515, and the polarization measurement unit 520. As shown in FIG. 21, the beam measurement device 70 may include all of the intensity distribution measurement unit 75, the beam divergence angle measurement unit 505, the pulse time-width measurement unit 515, and the polarization measurement unit 520.

The respective configurations of the intensity distribution measurement unit 75, the beam divergence angle measurement unit 505, the pulse time-width measurement unit 515, and the polarization measurement unit 520 are as described above. Here, for example, the high reflection mirror 76 may be replaced with the beam splitter 79, 506, 516 as shown in FIG. 21 for each of the intensity distribution measurement unit 75, the beam divergence angle measurement unit 505, and the pulse time-width measurement unit 515. Sensors such as the image sensors 78, 508, the biplanar photoelectric tube 518, and the energy sensors 528a, 528b are connected to the controller 80. Other configurations may be similar to those of the laser device 2C shown in FIG. 15.

### 6.2 Operation

The controller 80 may acquire a plurality of pieces of information of the beam width, the beam divergence angle, the TIS, and the polarization degree P before and after sliding based on the measurement information obtained from the plurality of measurement units among the intensity distribution measurement unit 75, the beam divergence angle measurement unit 505, the pulse time-width measurement unit 515, and the polarization measurement unit 520, and perform the deterioration determination pieces of information in combination. the deterioration In determination, it may be determined to have deteriorated when a plurality or one of the examples of the deterioration determination described above is satisfied. Other operation may be similar to that in the third embodiment.

### 6.3 Effect

According to the fourth embodiment, similar effects can be obtained as the third embodiment. Further, according to the fourth embodiment, it is possible to accurately determine deterioration of the optical element based on indices of various viewpoints.

### 7. Fifth Embodiment

### 7.1 Configuration

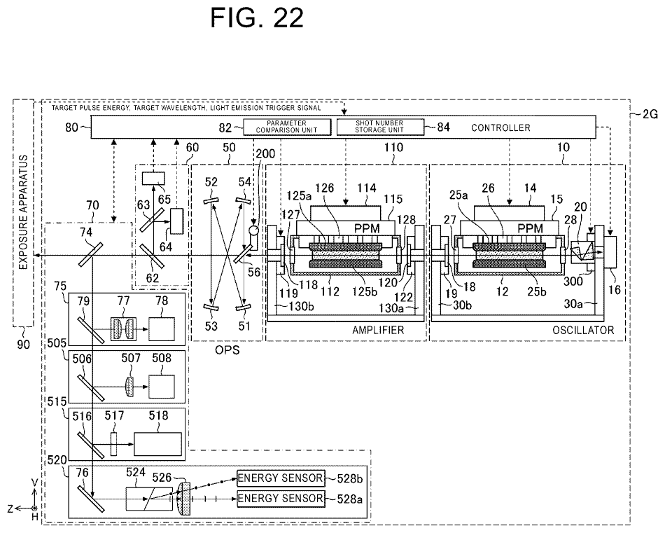

FIG. 22 schematically shows the configuration of a laser device 2G according to a fifth embodiment. The laser device 2G will be described in terms of differences from the laser device 2F (FIG. 21) according to the fourth embodiment.

The laser device 2G includes a power oscillator (PO) 110 on the laser light path between the oscillator 10 and the OPS 50. The amplifier 110 has a configuration similar to that of the oscillator 10. However, the amplifier 110 includes a partial reflection mirror 120 instead of the LNM 16 and the beam expander 20, and a base 122 instead of the mount 22. The partial reflection mirror 120 is an optical element that reflects a part of the pulse laser light output from the oscillator 10 and transmits the other part.

As shown in FIG. 22, the amplifier 110 includes a chamber 112, a charger 114, a PPM 115, an output coupling mirror 118, a slide mechanism-equipped base 119, the partial reflection mirror 120, the base 122, and cavity plates 130a, 130b. The chamber 112 includes a pair of discharge electrodes 125a, 125b, an insulating member 126, a front-side window 127, and a rear-side window 128. The chamber 112, the charger 114, the PPM 115, the cavity plates 130a, 130b, and the like may be similar to corresponding components of the oscillator 10.

The slide mechanism-equipped base 119 is arranged at the output coupling mirror 118 of the amplifier 110. The output coupling mirror 118 is fixed to the cavity plate 130b via the slide mechanism-equipped base 119. The output coupling mirror 18 of the oscillator 10 may be fixed to the cavity plate 30b via the base 19. The partial reflection mirror 120 is fixed to the cavity plate 130a via the base 122. The output coupling mirror 118 and the partial reflection mirror 120 configure an optical resonator. Other configurations are similar to those of the laser device 2F according to the fourth embodiment shown in FIG. 21.

### 7.2 Operation

The controller 80 performs control so that discharge occurs between the discharge electrodes 125a, 125b of the amplifier 110 at a timing when the pulse laser light output from the oscillator 10 enters the chamber 112 of the amplifier 110. The pulse laser light output from the oscillator 10 is amplified while reciprocating in the resonator of the amplifier 110, and is output from the output coupling mirror 118.

The deterioration determination of the optical elements in the laser device 2G is performed in the order of the beam expander 20, the beam splitter 56, and the output coupling mirror 118 of the amplifier 110. Other operation may be similar to that in the fourth embodiment.

### 7.3 Effect

According to the fifth embodiment, similar effects can be obtained as the fourth embodiment.

### 7.4 Modification

Each of the partial reflection mirror 120 of the amplifier 110 and the output coupling mirror 18 of the oscillator 10 shown in FIG. 22 may include a slide mechanism-equipped base. In this case as well, similarly to the second embodiment, the deterioration determination may be performed by sliding the optical element in order from the optical element having a lower deterioration rate. For example, the deterioration determination may be performed in the order of the beam expander 20, the output coupling mirror 18 of the oscillator 10, the beam splitter 56, the partial reflection mirror 120 of the amplifier 110, and the output coupling mirror 118 of the amplifier 110.

### 8. Comparison of Output Data of Beam Measurement Device

In the first to fifth embodiments described above, an example in which the parameters are calculated from the output data of the beam measurement device before and after the optical element is slid has been described, but not limited thereto, deterioration may be determined by comparing the output data of the beam measurement device 70 before and after sliding without calculating the parameters. For example, it may be determined that deterioration has occurred when a numerical value of a difference between the image data before and after sliding exceeds a predetermined value.

### 9. Modification of Laser Device

Instead of the oscillator 10 shown in FIG. 22, for example, a solid-state laser system including a semiconductor laser and a wavelength conversion system may be employed. The wavelength conversion system may configured using a nonlinear optical crystal. That is, the oscillation stage laser that generates seed light is not limited to a gas laser, and may be an ultraviolet solid-state laser that outputs pulse laser light having an ultraviolet wavelength. For example, the oscillation stage laser may be a solid-state laser that oscillates at a wavelength of about 193.4 nm, or an ultraviolet solid-state laser that outputs fourth harmonic light of a titanium-sapphire laser (wavelength of about 774 nm).

Further, not limited to the configuration including a Fabry-Perot resonator, the amplifier 110 may have a configuration including a ring resonator. Further, not limited to the configuration including an amplifier and an optical resonator, for example, it may have a configuration including a multi-pass amplifier that performs amplification by reflecting the seed light by a cylindrical mirror and causing the seed light to pass through a discharge space plurality times.

### 10. Electronic Device Manufacturing Method

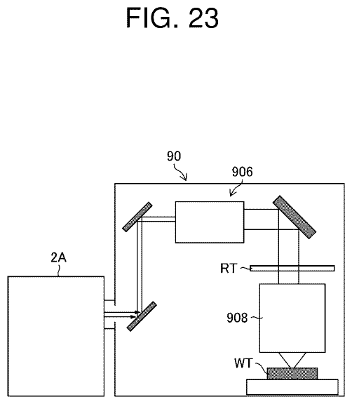

FIG. 23 schematically shows the configuration of the exposure apparatus 90. The exposure apparatus 90 includes an illumination optical system 906 and a projection optical system 908. The laser device 2A generates laser light and outputs the laser light to the exposure apparatus 90. The illumination optical system 906 illuminates a reticle pattern of a reticle (not shown) arranged on a reticle stage RT with laser light incident from the laser device 2A. The projection optical system causes 908 the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 90 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure. Not limited to the configuration using the laser device 2A, and any of the laser devices 2B to 2G may be used.

### 11. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser device comprising:
an optical element arranged on an optical path of laser light;
a movement mechanism configured to move the optical element in a direction along a surface of the optical element on which the laser light is incident;
a beam measurement device configured to measure the laser light via the optical element; and
a processor configured to acquire first output data output from the beam measurement device when the laser light is radiated to a first portion of the optical element, move the optical element after acquiring the first output data by driving the movement mechanism, acquire second output data output from the beam measurement device after the movement when the laser light is radiated to a second portion of the optical element different from the first portion, and determine deterioration of the optical element based on the first output data and the second output data.

2. The laser device according to claim 1,
wherein the first portion is used more frequently than the second portion.

3. The laser device according to claim 1,
wherein the processor drives the movement mechanism to return the optical element to an original position when the optical element is determined to have not deteriorated.

4. The laser device according to claim 1,
wherein each of the first output data and the second output data includes two-dimensional data indicating a light intensity distribution of the laser light.

5. The laser device according to claim 1,
wherein the processor determines deterioration of the optical element by calculating parameters each indicating a beam state of the laser light respectively from the first output data and the second output data, and comparing a value of the parameter calculated from the first output data with a value of the parameter calculated from the second output data.

6. The laser device according to claim 5,
wherein the parameters each include a beam width in a direction perpendicular to a travel direction of the laser light, and
the processor determines that the first portion of the optical element has deteriorated when the beam width calculated from the first output data is larger than α times the beam width calculated from the second output data, where α is a value used for a condition of the determination and is set to a value larger than 1.

7. The laser device according to claim 5,
wherein the parameters each include a beam width in an H direction perpendicular to a travel direction of the laser light and a beam width in a V direction perpendicular to the travel direction of the laser light and the H direction, and
the processor determines that the first portion of the optical element irradiated with the laser light at a position before the movement of the optical element for which the first output data is acquired has deteriorated when both of following expressions (a) and (b) are satisfied:
$$BPH 1 > BPH 2 \times α \qquad ( a )$$
$$BPV 1 > BPV 2 \times α \qquad ( b )$$
where BPH1 is the beam width in the H direction calculated from the first output data, BPV1 is the beam width in the V direction calculated from the first output data, BPH2 is the beam width in the H direction calculated from the second output data, BPV2 is the beam width in the V direction calculated from the second output data, and α is a preset value larger than 1.

8. The laser device according to claim 5,
wherein the parameters each include a beam cross-sectional area of the laser light, and
the processor determines that the first portion of the optical element has deteriorated when the beam cross-sectional area calculated from the first output data is smaller than β times the beam cross-sectional area calculated from the second output data, where β is a value used for a condition of the determination and is set to a value smaller than 1.

9. The laser device according to claim 5,
wherein the parameters each include a center difference indicating a difference between a center of gravity of a light intensity distribution of the laser light and a beam width center, and
the processor determines that the first portion of the optical element has deteriorated when an absolute value of a difference between the center difference calculated from the first output data and the center difference calculated from the second output data is larger than γ, where γ is a value used for a condition of the determination and is set to a value larger than 0.

10. The laser device according to claim 5,
wherein the parameters each include a beam divergence angle of the laser light, and
the processor determines that the first portion of the optical element has deteriorated when the beam divergence angle calculated from the first output data is larger than a times the beam divergence angle calculated from the second output data, where α is a value used for a condition of the determination and is set to a value larger than 1.

11. The laser device according to claim 5,
wherein the parameters each include a beam divergence angle in an H direction perpendicular to a travel direction of the laser light and a beam divergence angle in a V direction perpendicular to the travel direction of the laser light and the H direction, and
the processor determines that the first portion of the optical element irradiated with the laser light at a position before the movement of the optical element for which the first output data is acquired has deteriorated when both of following expressions (c) and (d) are satisfied:
$$BDH 1 > BDH 2 \times α \qquad ( c )$$
$$BDV 1 > BDV 2 \times α \qquad ( d )$$
where BDH1 is the beam divergence angle in the H direction calculated from the first output data, BDV1 is the beam divergence angle in the V direction calculated from the first output data, BDH2 is the beam divergence angle in the H direction calculated from the second output data, BDV2 is the beam divergence angle in the V direction calculated from the second output data, and a is a preset value larger than 1.

12. The laser device according to claim 5,
wherein each of the first output data and the second output data includes a light intensity time waveform of the laser light,
the parameters each include a pulse time width of the laser light, and
the processor determines that the first portion of the optical element has deteriorated when the pulse time width calculated from the first output data is smaller than β times the pulse time width calculated from the second output data, where β is a value used for a condition of the determination and is set to a value smaller than 1.

13. The laser device according to claim 5,
wherein each of the first output data and the second output data includes an energy of a polarization component of the laser light in a first direction and an energy of a polarization component of the laser light in a second direction perpendicular to the first direction,
the parameters each include a polarization degree of the laser light, and
the processor determines that the first portion of the optical element has deteriorated when the polarization degree calculated from the first output data is smaller than δ times the polarization degree calculated from the second output data, where δ is a value used for a condition of the determination and is set to a value smaller than 1.

14. The laser device according to claim 1,
further comprising a plurality of the movement mechanisms for moving a plurality of the optical elements, respectively,
wherein the processor specifies a deteriorated optical element from among the plurality of optical elements by moving the plurality of optical elements and performing the determination of deterioration.

15. The laser device according to claim 14,
wherein the processor performs the determination of deterioration while moving the plurality of optical elements in order from the optical element having a relatively lower energy load.

16. The laser device according to claim 14,
wherein the processor moves the deteriorated optical element and an optical element having a higher energy load than the deteriorated optical element among the plurality of optical elements when the deteriorated optical element is specified, and resumes use of the optical elements.

17. The laser device according to claim 1,
wherein the processor performs the determination of deterioration of the optical element by using a plurality of pieces of information among a light intensity distribution, a beam divergence angle, a pulse time width, an energy, and a polarization degree of the laser light in combination.

18. The laser device according to claim 1,
further comprising at least one of an output coupling mirror, a beam expander, and a beam splitter as the optical element.

19. A deterioration determination method of an optical element used for a laser device, comprising:
acquiring first output data output from a beam measurement device configured to measure the laser light via the optical element when laser light is radiated to a first portion of the optical element;
moving, after acquiring the first output data, the optical element in a direction along a surface of the optical element on which the laser light is incident;
acquiring, after moving the optical element, second output data output from the beam measurement device when the laser light is radiated to a second portion of the optical element different from the first portion; and
determining deterioration of the optical element based on the first output data and the second output data.
